(19) United States
(12) Patent Application Publication
(10) Pub. No.: US 2007/0095215 A1
(43) Pub. Date: May 3, 2007

(54) Pan with temperature displaying

(75) Inventors: Waiming Ho, Tsuen Wan (HK); Ming Lee, Sheung Wan (HK)

Correspondence Address: BUCHANAN, INGERSOLL & ROONEY PC, POST OFFICE BOX 1404, ALEXANDRIA, VA, 22313-1404, US

(73) Assignee: Mingle Metal (Shen Zhen) Co. Limited, Shenzhen (CN)

(21) Appl. No.: 11/389,287

(22) Filed: Mar. 27, 2006

(30) Foreign Application Priority Data
Oct. 27, 2005 (CN) 200520128117.4

(51) Int. Cl. A47J 43/28

(52) U.S. Cl. 99/342

(57) ABSTRACT

The invention discloses a pan with temperature displaying including a pan body and a handle, a temperature-sensing bimetal element being provided in the bottom of the pan body, a display means being provided in the handle, and the temperature-sensing bimetal element being connected with the display means. The invention can rapidly and precisely indicate the temperature of the pan bottom of the pan so that the user can control the cooking level during cooking. The pan according to the invention is of a simple structure, is convenient to use and is easy to popularize.

### TECHNICAL FIELD

The invention relates to a daily cooker, in particular to a pan with temperature displaying.

### TECHNICAL BACKGROUND

A pan is a sort of commonly used cooking device which is suitable for decocting, fig and stewing various foods. In order to improve the uniformity of the temperature in a pan, the bottom of the pan is usually composed of layers of metallic plate at different thickness. However, various pans in prior art do not have temperature displaying functions, so users have to control the duration and degree of cooking only by experience, such as cooking time, the frequency of tossing the food, the heating power of heating means, etc. In this case, some problems like overheating, burnt, crust sticking to pans and half-cooked easily occur so that the pans in prior art can not meet the requirements of the people satisfactorily.

### SUMMARY OF THE INVENTION

In view of the shortages of the pans in prior art, an object of the invention is to provide a pan with temperature displaying, which is of a simple structure and convenient to use.

To achieve this object, a solution according to this invention is to provide a pan with temperature displaying, said pan including a pan body, a handle, a temperature-sensing bimetal element positioned in the bottom of the pan body and display means located on the handle, wherein the temperature-sensing bimetal element is connected with the display means.

In a side face of said bottom of the pan body is provided a mounting hole extending inwardly at the distal end of which the temperature-sensing bimetal element is located. The temperature-sensing bimetal element is fixed at its front end and connected to the display means via a transmission mechanism at its rear end.

Said transmission mechanism includes metal rods and a flexible body. Said display means is a meter panel comprising a housing, a dial and a pointer. The temperature-sensing bimetal element at its rear end is connected with the pointer via the metal rods and the flexible body which are joined end to end, wherein the flexible body is situated at the turning point in the transmission path.

There are two said metal rods and one said flexible body. In this case, the flexible body is located between said two metal rods, and one metal rod is extended outwardly from the pan bottom, bent upwardly at a certain angle via the flexible body, and then connected with the pointer via the other metal rod.

Around said temperature-sensing bimetal element and the transmission mechanism is provided with a protection tube which extends from the distal end of the mounting hole all the way to the meter panel along a transmission direction, and the temperature-sensing bimetal element at its front end is fixed to the protection tube by a hollow head.

Bearings are provided between the two ends of said metal rod and the protection tube.

The metal rods are connected with the flexible body through flexible body fasteners.

Said mounting hole for the temperature-sensing bimetal element extends to a position near the center of the pan bottom and the upper surface of the pan bottom.

Said flexible body could be a spring.

Said mounting hole is situated right below the handle.

Due to the bottom of the pan body having a certain thickness, this invention proposes that the mounting hole is provided in the side face thereof then one high temperature resistant temperature-sensing bimetal element is mounted in the mounting hole, so as to detect the temperature of the pan bottom in use, wherein the temperature-sensing bimetal element is formed by winding a tape-shaped article made of two layers of different metal material. When the temperature changes, an angle change occurs in a vertical axial direction due to the different thermal expansion coefficients of the two layers of different metal material. Since one end of the temperature-sensing bimetal element is fixed to the hollow head and the hollow head in turn is fixed to the metal protection tube, an angle change will occur at the other end of the temperature-sensing bimetal element. The angle change causes the metal rod connected to the temperature-sensing bimetal element to rotate, the rotation of the metal rod in turn causes the flexible body connected thereto to rotate, the rotation of the flexible body in turn causes the other metal rod connected thereto to rotate, and the rotation of the other metal rod in turn causes the pointer fixed thereto to deflect at a certain angle. By comparing the pointer and the indication on the meter panel with marks indicating temperature difference, users can obtain the temperature of the pan bottom detected by the temperature-sensing bimetal element so that the meter panel can rapidly and precisely indicate the temperature of the pan bottom in use and users can control the duration and degree of cooking during cooking and reduce his work strength.

### DESCRIPTION OF FIGURES

FIG. 1 is a cross sectional view of a pan with temperature displaying according to the invention;

FIG. 2 is a partially enlarged schematic view of FIG. 1; and

FIG. 3 is a view in a B direction of FIG. 1, i.e. a schematic view of a meter panel.

### MODES OF CARRYING OUT THE INVENTION

The invention is further described in details in combination with the figures.

The following reference numbers denote:

1—a bottom plate of a pan body

2—a hollow head

3—a temperature-sensing bimetal element

4,11—a metal rod

5—a protection tube

6,10,12—bearings

7,9—a flexible body fastener

8—a flexible body

13—a handle

14—a gauge head housing

15—a surface

16—a transparent mirror

17—an indicating member

18—a hanging ring

19—a pointer bushing

20—a surface bushing

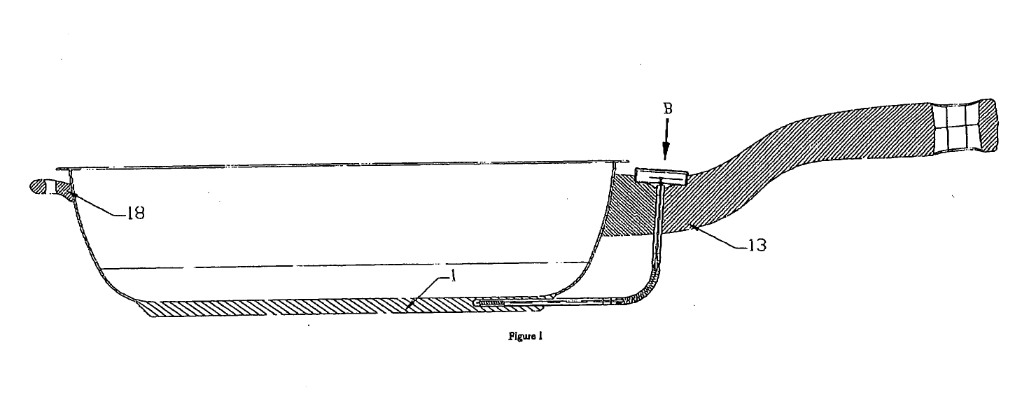

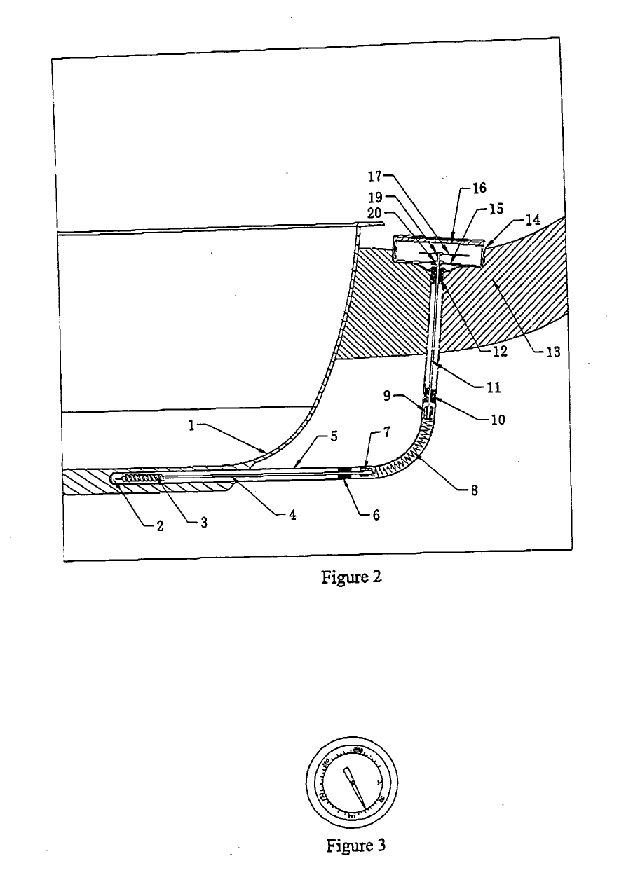

As shown in FIGS. 1 and 2, a handle 13 is mounted on one side of a pan body and a hanging ring 18 is mounted on another side thereof. A mounting hole extending inwardly is provided on a side surface of a bottom plate 1 of the pan body right below the handle 13, and extends inwardly about halfway towards the center of the pan bottom. Obviously, the mounting hole should extend inwardly as adjacent to the center of the pan bottom as possible, so as to be close to the center of a heat source and improve the accuracy of measurement. Since the bottom plate 1 of the pan body has a better heat conductivity, the mounting hole generally extends to a position ⅓ to ⅔ away from the center of the pan bottom to meet machining and mounting requirements. In addition, the position for mounting a temperature-sensing bimetal element is as close to an upper surface of the pan bottom as possible, so as to be able to detect the temperature of the pan bottom contacting food and reduce the error of measurement. The temperature-sensing bimetal element 3 is provided at a distal end of the mounting hole, an outer end of which element 3 is connected with an indicating member 17 of the meter panel on the handle by a metal rod 4, a flexible body 8 and a further metal rod 11. The indicating member 17 is riveted on the metal rod 11 via a pointer bushing 19. The two metal rods are connected with the flexible body via flexible body fasteners 7 and 9. The flexible body 8 mainly functions to change the direction of transmission and could be a spring. The metal rod 4 is extended outwardly from the pan bottom, bent upwardly about 90 degrees via the flexible body 8. Around the temperature-sensing bimetal element 3 and the transmission mechanism is provided a protection tube 5. The protection tube 5 extends from the distal end of is the mounting hole all the way to the meter panel along the transmission direction. The front end of the temperature-sensing bimetal element 3 is fixed to the protection tube 5 by a hollow head 2. A bearing 6 is provided between one end of the metal rod 4 and the protection tube. A bearing 10 and a bearing 12 are provided between the two ends of-the metal rod 11 and the protection tube.

The meter panel is located on the upper surface of the handle 13 close to the pan body and is mounted at a position for conveniently viewing. Of course, it can also be mounted at other positions. The meter panel mainly consists of a gauge head housing 14, a surface 15 marking a temperature difference (scales, colors or patterns etc., indicating the temperature), a transparent mirror 16, the indicating member 17 (which is normally in form of a pointer, but can also be in other forms), and a surface bushing 20 which fixes the surface on the housing. Associated components can be increased or saved, if necessary.

Though, not all pans are composed of a three-layered pan bottom structure. Some pan bottoms are of an integrated structure, some pans are wholly of a aluminum structure with only a layer of steel plate attached on the bottom, and some pans even have a compound bottom layer of more than three layers. Therefore, in practice, an appropriate manner of providing the mounting hole is selected depending on different pan bottom structures. If the pan is of a one-piece structure, the mounting hole is directly provided in a side face of its pan bottom. If the pan has a single interlayer, the mounting hole is provided in said single interlayer plate through the housing. If the pan has a compound bottom layer of a plurality of layers, the mounting hole is provided in the interlayer most close to the pan bottom. The mounting hole can be provided in more forms, but all are not apart from the technical solution as claimed in the application.

The invention is not limited to the above best modes of carrying out the invention, and anyone skilled in the art can achieve products of other various forms under the teachings of the invention. For example, a meter panel can be provided at other positions of the handle for the sake of the design of appearance, associated components of the transmission mechanism can be increased or reduced, and other transmission directions and connecting manners can be adopted. However, whatever modifications have been made to the shape or structure of the pan, a pan will fall in the protection scope of the invention, as long as the pan has the temperature-sensing bimetal element which is provided in the pan bottom and is connected with display means via a mechanical transmission structure.

1. A pan with temperature displaying, wherein the pan includes a pan body, a handle, a temperature-sensing bimetal element positioned in the bottom of the pan body and display means located on the handle, wherein the temperature-sensing bimetal element is connected with the display means.

2. A pan with temperature displaying as claimed in claim 1, wherein a mounting hole extending inwardly is provided in a side face of said bottom of the pan body, the temperature-sensing bimetal element is provided at a distal end of the mounting hole, a front end of the temperature-sensing bimetal element is fixed, and a rear end of the temperature-sensing bimetal element is connected with the display means via a transmission mechanism.

3. A pan with temperature displaying as claimed in claim 2, wherein said transmission mechanism includes metal rods and a flexible body, said display means is a meter panel including a housing, a dial and a pointer, and the rear end of the temperature-sensing bimetal element is connected with the pointer via the metal rods and the flexible body which are joined end to end, wherein the flexible body is situated at a turning point in a transmission path.

4. A pan with temperature displaying as claimed in claim 3, wherein there are two said metal rods and one said flexible body, wherein the flexible body is located between said two metal rods, one metal rod is extended outwardly from the pan bottom, bent upwardly at a certain angle via the flexible body, and connected with the pointer via the other metal rod.

5. A pan with temperature displaying as claimed in claim 4, wherein around said temperature-sensing bimetal element and the transmission mechanism is provided a protection tube which extends from the distal end of the mounting hole all the way to the meter panel along a transmission direction, and the front end of the temperature-sensing bimetal element is fixed to the protection by a hollow head.

6. A pan with temperature displaying as claimed in claim 5, wherein bearings are provided between two ends of said metal rods and the protection tube.

7. A pan with temperature displaying as claimed in claim 6, wherein said metal rods are connected with the flexible body through flexible body fasteners.

8. A pan with temperature displaying as claimed in claim 1, wherein said mounting hole for the temperature-sensing bimetal element extends to a position close to the center of the pan bottom and the upper surface of the pan bottom.

9. A pan with temperature displaying as claimed in claim 1, wherein said flexible body is a spring.

10. A pan with temperature displaying as claimed in claim 1, wherein said mounting hole is situated just below the handle.
